(19) United States
(12) Patent Application Publication
(10) Pub. No.: US 2012/0143583 A1
(43) Pub. Date: Jun. 7, 2012

(54) SYSTEM-LEVEL EMULATION/VERIFICATION SYSTEM AND SYSTEM-LEVEL EMULATION/VERIFICATION METHOD

(76) Inventors: Cheng-Yen Huang, Hsinchu City (TW); Cheng-Chien Chen, Taoyuan County (TW)

(21) Appl. No.: 12/960,532

(22) Filed: Dec. 5, 2010

(51) Int. Cl. G06F 17/50

(52) U.S. Cl. 703/14

(57) ABSTRACT

A system-level emulation/verification system includes an operating device for using a simulator to set soft intellectual properties (soft IPs) corresponding to a System-on-Chip (SOC) design module, executing a simulation corresponding to the SOC design module, and using a transactor to interact with the simulator via an Application Programming Interface (API); and a hard-wired based platform, including a hard IP corresponding to a soft IP of the SOC design module, wherein the hard-wired based platform sets the hard IP according to a setting of the SOC design module, and outputs an operating result of the hard IP corresponding to the setting of the SOC design module. The hard-wired based platform executes an IP model proxy for receiving an output of the transactor, transmitting the output to the hard-wired platform for controlling the operation of the hard IP, and transmitting the operating result to the transactor executed by the operating device.

### BACKGROUND OF THE INVENTION

1. Field of the Invention

The present invention relates to a circuit design emulation/verification system, and more particularly, to an emulation/verification system which can execute system-level emulations and verifications of a whole circuit system before a tape-out operation of the whole circuit system is executed.

2. Description of the Prior Art

With the advance of electronic technology, modern circuit systems are becoming highly complex and large-sized. This results in the need to test functionality of a whole circuit system as quickly as possible and to retrench the testing costs. Conventionally, circuit designers can only emulate and verify the whole circuit system to ensure system-level functionality after the hardware circuits corresponding to the whole circuit system have been substantiated, allowing the corresponding software to then be developed.

According to the teachings of U.S. Pat. No. 4,901,259, for speeding up these processes and reducing the product costs, some emulation/verification systems can execute partial emulating/verifying operations before the hardware circuits of the whole circuit system have been taped out to form a whole substantiated circuit system.

Each of the aforementioned testing platforms for executing emulation/verification before the tape-out of the whole circuit system has to be individually designed by a designer, however. The human resource costs and the required design period are significantly increased in order to provide this individual testing platform corresponding to the individual circuit system.

Even if the emulation/verification platforms can be provided with less effort and expenditure, the simulating costs will be increased due to the greatly used Field Programmable Gate Arrays (FPGAs) required by the emulation/verification platforms. Moreover, the FPGAs corresponding to the emulation/verification platforms cannot be operated at a speed as fast as the operating speed of substantiated circuits after the tape-out operations. In other words, since the operating speed of FPGAs, or so called “silicon-level speeds”, are much slower than the real speed of the substantiated circuits after the tape-out operations, the mismatch between the emulating/verifying results of the emulation/verification platforms and substantiated circuit systems is unavoidable.

Furthermore, each of the existing emulation/verification platforms may need their own particular Printed Circuit Boards (PCBs) or Evaluation Boards (EVB) for emulating/verifying specific circuit designs which will further raise the circuit costs and increase required time. In addition, when the circuit system is adjusted, the corresponding emulation/verification systems with many FPGAs need to repeatedly emulate/verify at different frequencies, which further extends the required time. Besides, modern FPGAs that are used in the emulation/verification platforms have different circuit details from the substantiated circuits and silicon samples formed by the tape-out process.

There is therefore a need to develop an emulation/verification method and emulation/verification system for promoting circuit-design functionality that can reduce the product costs and shorten the corresponding hardware developing periods.

### SUMMARY OF THE INVENTION

According to a first exemplary embodiment, a system-level emulation/verification system is disclosed. The system-level emulation/verification system comprises: an operating device, a hard-wired based platform, and serial link. The operating device executes a plurality of software modules. The plurality of software modules comprises a simulator and a transactor. The simulator sets soft intellectual properties (soft IPs) corresponding to a System-on-Chip (SOC) design module and executes a simulation corresponding to the SOC design module. The transactor interacts with the simulator via an Application Programming Interface (API). The hard-wired based platform comprises at least a hard IP. The hard IP corresponds to a soft IP of the soft IPs within the SOC design module. The hard-wired based platform sets the hard IP according to a setting corresponding to the SOC design module and outputs an operating result of the hard IP wherein the operating result corresponds to the setting of the hard IP. In addition, the hard-wired based platform executes an IP module proxy for receiving an output of the transactor from a message channel, and transmitting the output of the transactor to the hard-wired based platform for controlling the hard IP, and transmitting the operating result of the hard IP to the transactor via the message channel, wherein the transactor is executed by the operating device. The serial link is coupled to the operating device and the hard-wired based platform, for providing the message channel connecting the operating device and the hard-wired based platform.

According to another exemplary embodiment, a system-level emulation/verification method is disclosed. The system-level emulation/verification method comprises the following steps: setting soft IPS, which are situated within a simulator, corresponding to a SOC design module, and using the simulator for executing a simulation corresponding to the SOC design module; using a transactor for interacting with the simulator via an API; using a hard-wired based platform which comprises at least a hard IP, for setting the hard IP according a setting corresponding to the SOC design module and outputting an operating result of the hard IP accordingly, wherein the hard IP corresponds to a soft IP of the soft IPs within the SOC design module; and receiving an output of the transactor, via a message channel, and transmitting the output of the transactor to the hard-wired based platform for operating the hard IP accordingly, and transmitting the operating result of the hard IP to the transactor via the message channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system-level emulation/verification system according to a first exemplary embodiment of the present invention.

FIG. 2 is a flowchart of an exemplary embodiment of system-level emulation/verification method applied to the system-level emulation/verification system in FIG. 1.

FIG. 3 is a diagram illustrating operating details of an operating device of the system-level emulation/verification system according to an exemplary embodiment of the present invention.

FIG. 4 is a diagram illustrating operating detail of an operating device of the system-level emulation/verification system according to a further exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

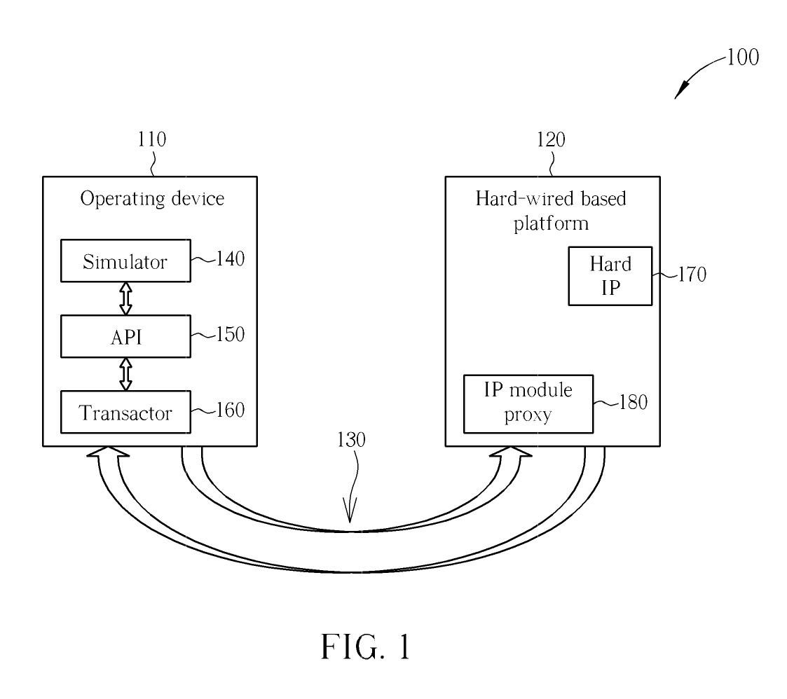

Please refer to FIG. 1. FIG. 1 is a diagram illustrating a system-level emulation/verification system according to a first exemplary embodiment of the present invention. As shown in FIG. 1, the system-level emulation/verification system 100 includes (but is not limited to): an operating device 110, a hard-wired based platform 120, and a serial link 130. The operating device 110 at least includes: a simulator 140, an API 150, and a transactor 160. The simulator 140 executes a simulation of a SOC design module. The operating device 110 uses the transactor 160 to interact with the simulator 140 via the API 150. Here the hard-wired based platform 120 includes a plurality of hardware elements: for example, the hard-wired based platform 120 may include at least a hard IP, and the hard-wired based platform 120 sets the hard IP 170 according to a setting of the SOC design module and transmits an operating result of the hard IP 170 corresponding to the aforementioned setting of the SOC design module to the simulator 140 within the operating device 110 via the serial link 130. However, FIG. 1 is one example only, and the number of hard IPs is not restricted to be one. In fact, the hard-wired based platform 120 may include a plurality of hard IPs. That is, the number of the hard IPs within in the hard-wired based platform 120 can differ according to the design considerations. In an exemplary embodiment, the SOC design module can be a SOC design created in programs (i.e., the SOC design is not taped-out and is not a substantiated hardware circuit system, and the operating device 110 emulates and verifies the SOC design module by using the simulator 140).

In this embodiment, the hard-wired based platform 120 receives the outputs from the transactor 160 via an IP module proxy 180 and the message channel (which is implemented by the serial link 130). In this way, the operations of the hard IP 170 may be controlled according to the outputs of the transactor 160. The hard-wired based platform 120 may further transmit the operating result outputted by the hard IP 170 to the transactor 160 via the serial link 130 by using the IP module proxy 180. In an exemplary embodiment of the present invention, the simulator 140, the API 150 and the transactor 160 can be realized by software modules. For example, the simulator 140 may interact with the transactor by using an API 150 realized by software programs, and the transactor 160 may be used to support transaction level circuit systems. The transactor 160 thereby may contact with the hard-wired based platform 120 through the messaged channel by translating the messages of the simulators. For the hard-wired based platform 120, the IP module proxy 180 serves as an interface between the hard-wired based platform 110 and the operating device 110, to thereby receive the translated messages from the transactor 160 via the message channel; the IP module proxy 180 also interprets the messages from the transactor 160. In this way, the hard-wired based platform 120 may instantiate and set the hard IPs (e.g., the hard IP 170) corresponding to (the soft IPs within) the SOC design module. That is, the hard-wired based platform 120 may set the hard IPs within the hard-wired based platform 120 according to the setting of the SOC design module within the simulator 140 to thereby allow the hard-wired based platform 120 to operate the hard IPs according to the settings of the soft IPs of the SOC design module within the simulator 140, and control the hard IP 170 to output the operating result corresponding to the setting of the soft IPs of the SOC design module. As a result, the hard-wired based platform 120 may interpret the operating result of the hard IP 170 to the simulator 140 via the IP module proxy 180 and transactor 160 within the operating device 110. Herein, the aforementioned operating result of the hard IP 170 corresponds to the setting of the soft IPs within the SOC design module; in other words, the setting of the hard IP 170 disposed on the hard-wired based platform 120 is identical to a corresponding setting of one soft IP of the soft IPs within the SOC design module.

In an exemplary embodiment, the operating device 110 may be implemented by a personal computer (PC) or a work station, and the hard IP 170 corresponds to a soft IP within the SOC design module, wherein the SOC design module is executed by the simulator 140. In addition, the system-level emulation/verification system 100 may use a substantiated serial link 130 as the message channel between the operating device 110 and the hard-wired based platform 120. By using the operating device 110, the simulator 140, the API 150 and the transactor 160 within the operating device 110, and by using the hard-wired based platform 120 and the hard IPs corresponding to the soft IPs of the SOC design module, the system-level emulation/verification system of the present invention thereby provides a system-level emulation/verification function before a tape-out operation of a complete SOC design module is executed. That is, the system-level emulation/verification system executes the system-level emulation/verification operation by using at least a hard IP 170 corresponding to one soft IP of the soft IPs within the SOC design module according to the operating results of partial substantiated circuits, where the operating device 110 acknowledges the operating results of partial substantiated circuits corresponding to the SOC design module by receiving the said operating results to the simulator 140 for thereby executing the system-level emulation/verification before the complete SOC design module is taped-out to corresponding complete substantiated circuit system. Please note the aforementioned embodiments are preferred embodiments only but are not meant to be limitations of the present invention; for example, the operating device 110 and the hard-wired based platform 120 may further include more software modules and/or hardware modules, and for the sake of briefness, the system-level emulation/verification system in FIG. 1 only illustrates elements related to the embodiment. In some other embodiments, the IP module proxy 180 may be realized by selectively using software and hardware modules or a combination of the two, for interacting with the simulator 140 within the operating device 110 from the transactor 160 via substantiated serial link 130. Moreover, the hard-wired based platform 120 may further use a control circuit (not shown) to control and manage the hard IP within the hard-wired based platform 120 via the IP module proxy 180. This is for illustrative purposes only, and is not meant to be a limitation of the present invention. That is, any system-level emulation/verification system which uses the operating device 110 to execute the simulator 140 for executing the emulation/verification operation of a circuit module system formed by programs by using partial substantiated hardware modules (e.g., the hard IP 170) to emulate and verify accordingly at a speed of substantiated circuits, such as the silicon level speed and transmit the corresponding operating result of the partial substantiated hardware modules to the simulator 140, thereby accomplishing the system-level emulation/verification of the complete circuit module system by executing the simulator 140 before the whole circuit module system is taped-out and before the circuit module system is substantiated from programs, to reduce the required developing period, obeys the spirit of the present invention and falls within the scope of the present invention.

For example, with appropriate design variations, the alternative system-level emulation/verification systems having various structures may be used to execute the SOC design circuit (e.g., the aforementioned SOC design module) formed by the programs within the simulator 140 of the operating device with the cooperation of the transactor 160 and the IP module proxy 110, and by using the at least one hard IP disposed on the hard-wired based platform 120 to execute the simulation of the corresponding soft IP of the SOC design circuit, to thereby improve the functionality of the system-level emulation/verification and reduce the required cost. It obeys the spirit of the present invention and falls within the scope of the present invention.

In addition, in another exemplary embodiment of the present invention, the system-level emulation/verification system 100 may comply with a specification of Standard Co-Emulation Modeling Interface (SCE-MI). The API 150 may be software corresponding to an Advanced Microcontroller Bus Architecture-Advanced High-Performance (AMBA-AHB) Bus. Due to the details of the transactor 160 and the transaction level design being well known by people familiar with the designs of the electrical system-level, further description is omitted here.

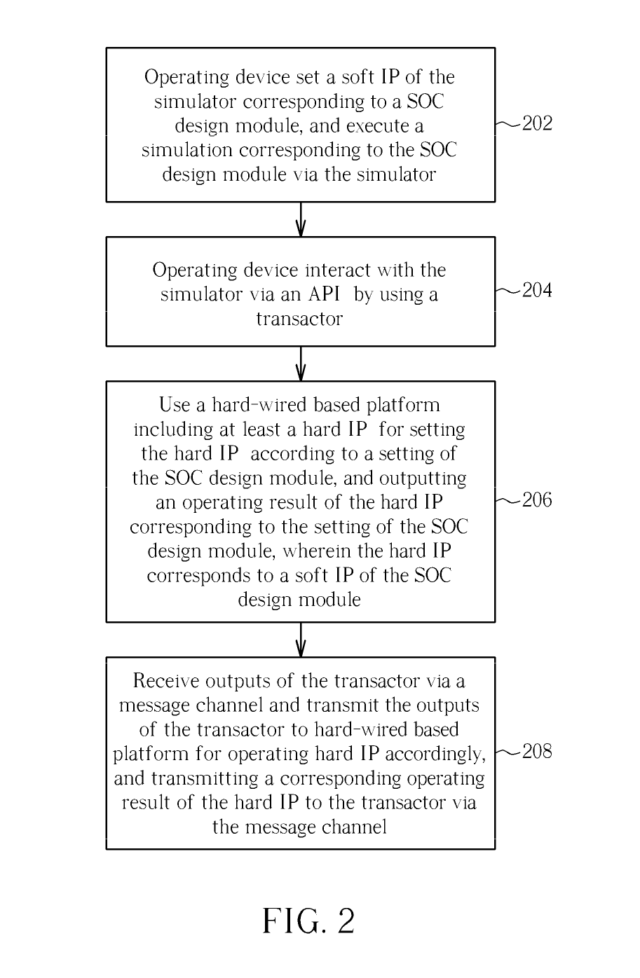

Please refer to FIG. 2. FIG. 2 is a flowchart of an exemplary embodiment of system-level emulation/verification method applied to the system-level emulation/verification system in FIG. 1. Provided that the result is substantially the same, the steps are not required to be executed in the exact order shown in FIG. 2. The exemplary system-level emulation/verification method may be briefly summarized as follows:

Step 202: The operating device 110 sets a soft IP of the simulator 140, the soft IP corresponding to a SOC design module, and executes a simulation corresponding to the SOC design module via the simulator 140. The simulator 140 may be realized by software languages or soft programs within the operating device 110, and the SOC design module may be a SOC design circuit formed by the programs. The operating device 110 may set the soft IPs corresponding to the SOC design module (formed by the programs) and other elements corresponding to the SOC design module to execute the emulation/verification of the SOC design module, wherein the said elements corresponding to the SOC design module are also formed by programs. In an exemplary embodiment, the transactor 140 may be a software module executed by the operating device 110 for translating the outputs of the simulator 140 to make the interpreted outputs to be messages which can be read by the IP module proxy 180 of the hard-wired based platform 120. Furthermore, in another alternative embodiment, the operating device 110 may execute a test bench via the simulator 140 for executing the simulation of the SOC design module. Before executing the simulation of the SOC design module by the simulator 140, the simulator 140 will instantiate soft IPs corresponding to the SOC design module for setting the soft IPs corresponding to the SOC design module; the setting of the SOC design module at least includes the setting of soft IP(s) within the SOC design module. The hard-wired based platform 120 may then set the hard IP 170 according to the setting of one soft IP of the soft IPs, wherein the hard IP 170 corresponds to the specific soft IP. In this way, the setting of the hard IP 170 is identical to that of the corresponding soft IP.

Step 204: The operating device 110 interacts with the simulator 140 via an API 150 by using a transactor 160. In an exemplary embodiment, the API 150 may be a software programs corresponding to an AMBA-AHB.

Step 206: The system-level emulation/verification system 100 use a hard-wired based platform 120 having at least a hard IP 170 for setting the hard IP 170 according to a setting of the SOC design module, and outputting an operating result of the hard IP 170 corresponding to the setting of the SOC design module. The hard IP 170 corresponds to a soft IP of the SOC design module. However, the number of hard IPs here is not a limitation of the present invention. For example, with appropriate design variations, when the SOC design module being simulated by the simulator 140 has a plurality of soft IPs, and the hard-wired based platform 120 includes a plurality of hard IPs wherein each hard IP of the hard IPs corresponding to one soft IPs of the soft IPs, then each of the hard IPs can be set individually according to the setting of the SOC design module. Hence the hard IPs disposed on the hard-wired based platform 120 can be used to execute the simulation corresponding to the setting of the SOC design module at a silicon-level speed, and the operating result of the simulation can thereby be transmitted to the simulator 140 within the operating device 110 for supporting the following system-level emulation/verification. Extensively, by using the system-level emulation/verification system of the present invention, the hard IPs and other substantiated hardware elements disposed on the hard-wired based platform 120 can be used for executing the simulations of the corresponding soft IPs and software structures of the operating device 110, to thereby accomplish system-level emulation/verification. The hard IPs may correspond to each of the soft IPs of the SOC design module, respectively, and the substantiated hardware structures (e.g., a storage device) disposed on the hard-wired based platform 120 may correspond to a storage module formed by programs within the simulator 140. These alternative designs obey and fall within the scope of the present invention.

Step 208: The outputs of the transactor 160 are received via a message channel and the outputs of the transactor 160 are transmitted to the hard-wired based platform 120 for operating the hard IP 170 accordingly, and a corresponding operating result of the hard IP 170 is transmitted to the transactor 160 via the message channel. In the system-level emulation/verification system 100 in FIG. 1, the message channel is realized by a substantiated serial link 130 as the bridge between the operating device 110 and the hard-wired based platform 120. However, any structure can be used to provide the required message channel to be the serial link 130 of the present invention. The alternative designs obey and fall within the scope of the present invention.

In another exemplary embodiment of the present invention, the hard-wired based platform 120 may have additional hardware modules, such as memory units. When the hard-wired based platform 120 includes a plurality of hard IPs (not shown) and/or hard modules corresponding to a plurality of soft IPs and software modules within the SOC design module, respectively, wherein the soft IPs and software modules are constructed by the programs, the hard-wired based platform 120 can then set the hard IPs and hardware modules disposed on the hard-wired based platform 120, respectively, according to the corresponding soft IPs and software modules within the SOC design module via the transactor 160 and the IP module proxy 180, and operate the hard IPs and hard modules with a real speed (e.g., a silicon level speed) of substantiated circuits, and transmit the corresponding operating results to the simulator 140. In this way, the simulator 140 can execute a simulation of the SOC design module according to the operating results executed by the substantiated hard IPs and hardware modules. This also falls within the scope of the present invention.

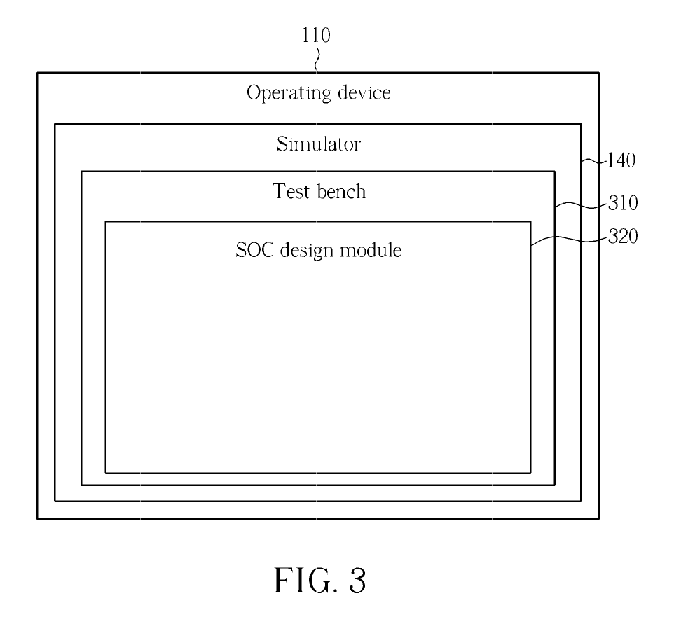

Please refer to FIG. 3. FIG. 3 is a diagram illustrating operating details of an operating device of the system-level emulation/verification system according to an exemplary embodiment of the present invention. As shown in FIG. 3, the operating device 110 may be accomplished by a PC or work station, and the simulator 140 may be the software platforms thereon. The SOC design module 320 may be design circuits constructed in programs. The simulator 140 may execute a test bench 310 for executing system-level emulation/verification before the SOC design module 320 become substantiated circuit system. Since the test bench 310 and the SOC design module 320 constructed in programs are well known by people familiar with electronic system-level design, and the details of the operating device 110, the simulator 140 and the SOC design module have been disclosed in above paragraphs of, further description is omitted.

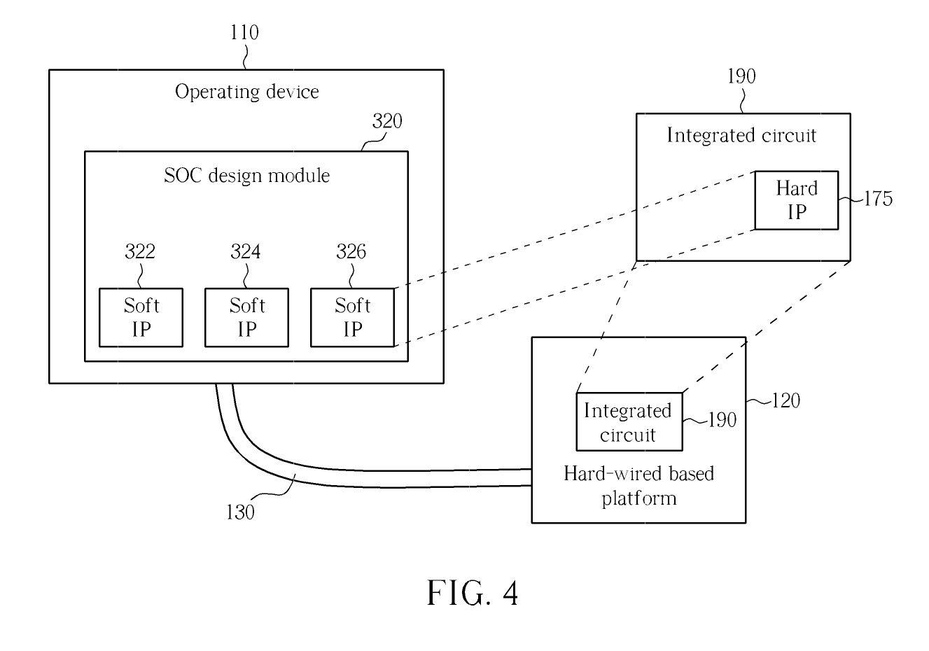

Please refer to FIG. 4 in conjunction with FIG. 1 and FIG. 2. FIG. 4 is a diagram illustrating operating details of an operating device of the system-level emulation/verification system according to another exemplary embodiment of the present invention. As shown in FIG. 4, the system-level emulation/verification of the SOC design module 320 is executed by the operating device 110 by using the simulator, and the SOC design module 320 is a circuit system formed by programs. For example, the SOC design module can be constructed by verilog or other hardware description language(s) (HDL), and a test bench may be executed for executing the emulation/verification of the SOC design module 320.

Before the system-level emulation/verification is executed, the operating device 110 may instantiate and set the soft IPs (e.g., the soft IPs 322, 324, and 326) within the SOC design module 320 via the simulator, wherein the simulator can be realized by a software module. When there is a hard IP 175 within the integrated circuit (IC) 190 on the hard-wired based platform 120, and the hardware structure of the hard IP 175 corresponds to the soft IP 326 constructed in HDL, then the hard-wired based platform 120 may receive the setting details of the soft IP 326 from the transactor (not shown) of the operating device 110 via the IP module proxy (not shown) and the serial link 130, and transmit the setting details of the soft IPs 326 to the IC 190 for setting the hard IP 175. Therefore, when the simulator (not shown) executes the test bench for executing the simulation corresponding to the soft IP 326, the hard IP 175 may operate according to its setting, where its setting corresponds to the setting of the soft IP 326. The generated operating result of the hard IP 175 corresponding to the setting of the soft IP 326 will then be transmitted to the simulator via the serial link 130. Consequently, the system-level emulation/verification system and system-level emulation/verification method can use the hard IPs and other hardware modules hard-wired based platform 120 corresponding to the SOC design module 320 to execute the corresponding simulations at a silicon speed and transmit the operating results to the simulator. This process thereby accomplishes the system-level simulation/verification of the SOC design module 320 before the SOC design module 320 is taped-out and becomes a substantiated circuit system.

In another exemplary embodiment of the present invention, the test bench to be used for executing the emulation/verification of the SOC design module formed by the programs can further describe the behaviors of additional hardware modules. For instance, when a hard disc is disposed on the hard-wired based platform, such as a universal serial bus (USB) disc, then the test bench can further describe the behaviors between the soft IPs and the soft memory module(s) within the SOC design modules corresponding to the USB disc. In this way, when the test bench executes the simulations corresponding to the particular soft IPs and the software memory modules within the SOC design modules, wherein the software memory modules correspond to the USB disc, the corresponding hard IP disposed on the hard-wired based platform and the corresponding USB disc will operate at a silicon speed according to the setting of the test bench and the setting of the SOC design module and transmit the operating results to the simulator. Any emulation/verification system supporting the transaction level, however, such as the system-level emulation/verification system which complies with the specification of SCE-MI or other associated specifications, and uses at least substantiated hard IPs and/or hardware module(s) disposed on the hard-wired based platform 120 to generate operating results of the aforementioned hard IP and/or hardware module(s) operated in a silicon-level speed to thereby help the system-level emulation/verification of the whole circuit system before the tape-out operation is executed, obeys and falls within the scope of the present invention.

In conclusion, by using the system-level emulation/verification system and the system-level emulation/verification method of the present invention, the number of required FPGAs can be reduced. By using the hard IPs disposed on the hard-wired based platform to execute the simulations of the corresponding partial soft IPs of the SOC design module and transmit the corresponding operating result, a much more reliable system-level emulation/verification is realized and the required period for the software system to be applied is reduced.

Those skilled in the art will readily observe that numerous modifications and alterations of the device and method may be made while retaining the teachings of the invention.

What is claimed is:

1. A system-level emulation/verification system, comprising:
an operating device, for executing a plurality of software modules, the software modules comprising:
a simulator, for setting soft intellectual properties (soft IPs) corresponding to a System-on-Chip (SOC) design module, and executing a simulation corresponding to the SOC design module; and
a transactor, interacting with the simulator via an Application Programming Interface (API);
a hard-wired based platform, comprising:
at least a hard IP, corresponding to a soft IP of the soft IPs within the SOC design module, wherein the hard-wired based platform sets the hard IP according to a setting corresponding to the SOC design module and outputs an operating result of the hard IP and the operating result corresponds to the setting of the hard IP, in addition, the hard-wired based platform executes an IP module proxy for receiving an output of the transactor from a message channel, transmitting the output of the transactor to the hard-wired based platform for controlling the hard IP, and transmitting the operating result of the hard IP to the transactor via the message channel, wherein the transactor is executed by the operating device; and
a serial link, coupled to the operating device and the hard-wired based platform, for providing the message channel connecting the operating device and the hard-wired based platform.

2. The system-level emulation/verification system of claim 1, wherein the hard-wired based platform operates the hard IP at a silicon-level speed, and the hard IP corresponds to the soft IP of the soft IPs within the SOC design module.

3. The system-level emulation/verification system of claim 1, wherein the operating device executes the simulation of the SOC design module by using the simulator to execute a test bench; after the simulator instantiates each of the soft IPs to which the SOC design module corresponds, the simulator executes the simulation corresponding to the SOC design module; and, the setting of the SOC design module comprises settings of each of the soft IPs so that the hard-wired based platform sets the hard IP according to the setting of the corresponding soft IP of the soft IPs.

4. The system-level emulation/verification system of claim 1, wherein the operating device uses the transactor for interacting with the IP module proxy via the message channel, and the operating device translates messages of the simulators by executing the transactor, and transmits the messages to the hard-wired based platform via the IP module proxy.

5. The system-level emulation/verification system of claim 4, wherein the API corresponds to an Advanced Microcontroller Bus Architecture-Advanced High-Performance Bus (AMBA-AHB).

6. The system-level emulation/verification system of claim 1, wherein the system-level emulation/verification system complies with a specification of Standard Co-Emulation Modeling Interface (SCE-MI).

7. The system-level emulation/verification system of claim 1, wherein emulations and verifications of a whole circuit system are executed before executing a tape-out operation of the whole circuit system.

8. A system-level emulation/verification method, comprising:
setting soft intellectual properties (soft IPs) within a simulator, corresponding to a SOC design module, and using the simulator for executing a simulation corresponding to the SOC design module;
using a transactor for interacting with the simulator via an Application programming Interface (API);
using a hard-wired based platform which comprises at least a hard IP, for setting the hard IP according to a setting corresponding to the SOC design module, and outputting an operating result of the hard IP accordingly, wherein the hard IP corresponds to a soft IP of the soft IPs within the SOC design module; and
receiving an output of the transactor via a message channel, transmitting the output of the transactor to the hard-wired based platform for operating the hard IP accordingly, and transmitting the operating result of the hard IP to the transactor via the message channel.

9. The system-level emulation/verification method of claim 8, which operates the simulation corresponding to the SOC design module at a silicon-level speed.

10. The system-level emulation/verification method of claim 8, wherein the step of using the simulator for executing the simulation corresponding to the SOC design module executes the simulation corresponding to the SOC design module by executing a test bench by the simulator; the step of setting the soft IPs corresponding to the SOC design module within the simulator comprises:
after the simulator instantiating each of the soft IPs to which the SOC design module corresponds, the simulator executes the simulation corresponding to the SOC design module; wherein the setting of the SOC design module comprises settings of each of the soft IPs so that the hard-wired based platform sets the hard IP according to the setting of the corresponding soft IP of the soft IPs.

11. The system-level emulation/verification method of claim 8, wherein the step of using the transactor for interacting with the simulator via the API comprises:
translating messages of the simulator and transmitting the messages via the message channel.

12. The system-level emulation/verification method of claim 11, wherein the API corresponds to an Advanced Microcontroller Bus Architecture-Advanced High-Performance Bus (AMBA-AHB).

13. The system-level emulation/verification method of claim 8, wherein the system-level emulation/verification system complies with a specification of Standard Co-Emulation Modeling Interface.

14. The system-level emulation/verification method of claim 8, being executed before executing a tape-out operation of a corresponding whole circuit system.
